(19) United States
(12) Patent Application Publication
(10) Pub. No.: US 2021/0148483 A1
(43) Pub. Date: May 20, 2021

(54) Valve Arrangement For A Motor Vehicle

(71) Applicant: CPT Group Gmbh, Hannover (DE)

(72) Inventors: Christian WEIS, Budenheim (DE); Carsten MIKOLAJEK, Griesheim (DE)

(21) Appl. No.: 16/472,456

(22) PCT Filed: Dec. 13, 2017
(86) PCT No.: PCT/EP2017/082706

§ 371 Date: Jun. 21, 2019

(30) Foreign Application Priority Data
Dec. 22, 2016 (DE) 10 2016 226 111.8

(51) Int. Cl. F16K 31/04; F02M 26/67

(52) U.S. Cl. CPC F16K 31/047; F16K 31/53; F02M 26/67

(57) ABSTRACT

A valve arrangement for a motor vehicle has a valve plunger fixedly connected to a closure member, a valve housing, a valve seat, an electric motor configured to move the valve plunger, and a worm gear has an outer thread and an inner thread. The valve plunger has, at least in a sub-region, an outer thread and the valve arrangement has a threaded sleeve with an inner thread or a spindle nut with an inner thread, or the valve plunger is fixedly connected to a component having an inner thread and the valve arrangement has an outer thread. The valve plunger is connected to a first gearwheel, and the valve arrangement has at least one second gearwheel. The second gearwheel is arranged such that it can transmit a rotational movement directly, or via an intermediate gearing, to the first gearwheel.

### CROSS REFERENCE TO RELATED APPLICATIONS

This is a U.S. national stage of International application No. PCT/EP2017/082706, filed on Dec. 13, 2017, which claims priority to German Application No. 10 2016 226 111.8, filed Dec. 22, 2016, the content of each of which is incorporated herein by reference.

### BACKGROUND OF THE INVENTION

### 1. Field of the Invention

The invention relates to a valve arrangement for a motor vehicle.

### 2. Description of the Prior Art

The principle of converting rotational movements of a drive motor into linear movements for the purpose of actuating a valve is also applied, for example, in valves for controlling exhaust gas recirculation in motor vehicles. Various embodiments of valves and valve arrangements for motor vehicles, which have electric motors for the valve drive, are known. For this purpose, use is often made of a transmission mechanism that converts the rotational movement into a linear or translatory movement by a corresponding kinematic mechanism. The conversion of the rotational movement may be realized, for example, via a crank drive or a slotted-link mechanism.

A disadvantage of devices of this type is, in particular, that, during the conversion of the movement, undesired transverse forces are generated, which can be transmitted to the valve plunger or to the valve disk. This leads to greater wear and to a reduced lifetime. Also, jamming of the valve can occur.

It is furthermore a disadvantage that, in particular, slots in slotted-link mechanisms have to be produced with very high production accuracy so that the play at the valve disk and the valve plunger is kept as small as possible. It is also a disadvantage that, owing to installation space requirements and the structural design of crank drives or slotted link drives, it is often the case that only one-sided mounting of the valve plunger is provided, which can result in tilting or jamming of the valve plunger.

It is moreover a disadvantage that transmission devices realized via a crank drive or a slotted-link mechanism necessitate complicated assembly processes, production processes or complex individual components such as oblique covers, which in turn can make the production of a device particularly cumbersome or expensive overall.

### SUMMARY OF THE INVENTION

It is thus an object of the present invention to provide a valve arrangement for a motor vehicle, which exhibits improved, more reliable transmission of the rotational movement of a drive motor into a linear movement of a valve plunger.

The valve arrangement according to an aspect of the invention for a motor vehicle, has a valve plunger, which is fixedly connected to a closure member, a valve housing, having a valve seat, and an electric motor by which the valve plunger is able to be moved. The valve arrangement has a worm gear with an outer thread and an inner thread, wherein the valve plunger has, at least in a sub-region, an outer thread and the valve arrangement has a threaded sleeve with an inner thread or a spindle nut with an inner thread, or the valve plunger is fixedly connected to a component having an inner thread and the valve arrangement has an outer thread, and the valve plunger is connected to a first gearwheel, and the valve arrangement has at least one second gearwheel, wherein the second gearwheel is arranged such that it can transmit a rotational movement directly, or via an intermediate gearing, to the first gearwheel.

The linear movement (that is to say an opening/closing) of the valve/valve arrangement is, according to one aspect of the invention, realized by a linear movement of the plunger, to which the valve disk is attached. In one setting, the disk closes off the valve channel. The valve arrangement has a worm gear with an outer thread and an inner thread, and the plunger is moved linearly by the worm gear, in the form of a spindle drive. In this case, the plunger, connected to a gearwheel, is set in rotation by a further gearwheeldriven by an electric motor. The plunger has an outer thread, for example a threaded spindle, which runs in an inner thread, or the plunger is fixedly connected to a component having an inner thread, in which inner thread an outer thread of the valve arrangement runs. Consequently, an axial, linear movement of the plunger occurs when the plunger is radially set into rotation. Overall, the plunger therefore simultaneously performs a rotational movement about its longitudinal axis and a linear movement along its longitudinal axis, this corresponding to the actuation of the valve of the valve arrangement according to the invention.

In one valve arrangement according to an aspect of the invention, the outer thread in a sub-region of the valve plunger interacts with the threaded sleeve or spindle nut like a spindle drive with threaded spindle and threaded nut. Here, an outer thread on the threaded plunger and the threaded sleeve or spindle nut form a worm gear, that is to say the outer thread on the valve plunger runs in the inner thread of the threaded sleeve in an engaged manner.

In a further valve arrangement according to the invention, the inner thread which the component fixedly connected to the valve plunger has acts like a threaded sleeve or spindle nut and forms together with an outer thread of the valve arrangement like a spindle drive with threaded spindle and threaded nut. In this case, the outer thread of the valve arrangement and the inner thread at the first gearwheel form a worm gear, that is to say the component fixedly connected to the valve plunger runs with its inner thread on the outer thread of the valve arrangement. The outer thread may, for example, be fixedly arranged on the housing of the valve arrangement.

In the context of a valve arrangement according to the invention, both force-fitting and form-fitting gearwheels are possible. A gearwheel may, for example, be a toothed wheel or a friction wheel. A friction wheel may consist for example of rubber or an elastomer.

A valve arrangement according to the invention allows switching times in the region of 100 ms.

In an exemplary embodiment of the present valve arrangement, a pair of stops for limiting a movement are configured such that one stop is attached to the first gearwheel and the second stop is attached to the housing. Here, the stops are arranged such that they do not influence the movements of the gearwheel, unless the gearwheel reaches the stop position. In this position, the two stops are in contact and, in this way, limit the rotational movement of the gearwheel about its axis of rotation. With the contact of the stops, a force acts between the stops in a tangential direction with respect to the rotational movement of the gearwheel. In one simple case, the stops each have surfaces which, with respect to the rotational movement of the gearwheel, are oriented radially, that is to say perpendicularly with respect to the vector of the force/bearing moment which arises. The surfaces come into contact in the limitation setting. The formation of the stops, however, is not restricted to this form. Rather, this simple example serves merely for illustrative purposes, and a wide variety of formations of the stops are possible. The interaction of the stops results in a rotational movement of the first gearwheel—and thus also of the valve plunger fixedly connected thereto—about the axis of rotation of the gearwheel—and thus also about the longitudinal axis of the plunger—being limited. In comparison with limitation by way of stops, which do not directly limit a rotational movement but rather firstly limit a longitudinal movement of the gearwheel (and furthermore then also, as an indirect consequence, the rotational movement) in that they are situated axially opposite one another, the embodiment specified here advantageously offers reduced friction between the stops and thereby a greater service life of stops, gearwheel and drive motor.

In a particularly advantageous embodiment of a valve arrangement according to an aspect of the invention, a force-fitting gearwheel engagement between the first and second gearwheels is achieved over the entire stroke of the plunger in that one of the gearwheels or both gearwheels is/are extended along the axis of the direction of stroke movement of the plunger such that, in all plunger positions, a sufficient overlap of the first and second gearwheels is ensured.

In a further particularly advantageous embodiment of a valve arrangement according to an aspect of the invention, having at least one third gearwheel, which, as an intermediate gearwheel, imparts a rotational movement between the first and second gearwheels, a force-fitting gearwheel engagement between the first and a third gearwheel or between the second gearwheel and a third gearwheel is achieved over the entire stroke of the plunger in that at least one third gearwheel is extended along the axis of the direction of stroke movement of the plunger such that, in all plunger positions, a sufficient overlap for achieving in a force-fitting manner a rotational movement of the gearwheels is ensured. In a further particularly advantageous embodiment, a plurality of third gearwheels are used as intermediate wheels and either one or a plurality of intermediate wheels are extended. Additionally, it is possible for the first and/or the second gearwheel to be extended too.

In a particularly advantageous embodiment of a valve arrangement according to an aspect of the invention, the closure member bears sealingly against the valve seat in the closed setting of the valve. This particularly advantageously results in the valve being sealed off by direct contact between the closure member and the seat. The seating of the closure member on the valve seat constitutes the stop of the linear movement of the closure member and thus of the valve plunger too, which stop limits the movement during a closing process of the valve/valve arrangement.

One particularly advantageous embodiment of a valve arrangement according to an aspect of the invention additionally has a magnetic field sensor, wherein, additionally, a magnet is arranged in a manner connected to the valve plunger such that the setting of the valve can be detected by the magnetic field sensor. In this way, contactless detection of the position and/or setting of the valve plunger becomes particularly advantageously on. Furthermore it in turn becomes clear whether the valve arrangement is in an open state, a closed state or an intermediate state.

In one particularly advantageous embodiment of a valve arrangement according to an aspect of the invention, the magnet arranged on the valve plunger has a cylindrical shape. A magnet of cylindrical shape can particularly advantageously be produced in a cost-effective manner.

Contactless detection of the position and/or setting of the valve plunger simultaneously allows the switching state of the valve/valve arrangement to be detected overall. For such detection by way of a magnet arranged on the valve plunger and a magnetic field sensor, magnets of high homogeneity are particularly suitable.

In one particularly advantageous embodiment of a valve arrangement according to an aspect of the invention, the valve plunger is constructed from solid material such that it also comprises the outer thread. Such a configuration particularly advantageously permits the plunger and outer thread to be produced on the one hand in a particularly robust manner and on the one hand in an integral manner.

In another particularly advantageous embodiment of a valve arrangement according to an aspect of the invention, the outer thread is attached to the valve plunger by a separate sleeve. This, for example, particular advantageously allows the plunger, firstly, and the thread, secondly, to be produced from different materials.

In another particularly advantageous embodiment of a valve arrangement according to an aspect of the invention, the outer thread or the inner thread is attached to the valve plunger by injection molding. Consequently, it is advantageously possible for the outer thread to be attached particularly economically, in terms of the process, and cost-effectively.

In one particularly advantageous embodiment of a valve arrangement according to an aspect of the invention, the first gearwheel and the outer thread are produced as a single-piece injection molding. The joint production particularly advantageously allows intermediate steps in the production to be omitted and quality controls to be reduced. This applies in a similar manner to a variant of the particularly advantageous embodiment of a valve arrangement according to the invention, in which variant the first gearwheel and the inner thread are produced as a single-piece injection molding. Here, the first gearwheel, which is fixedly connected to the valve plunger, and an inner thread are combined in one component. The inner thread then forms, together with an outer thread of the valve arrangement, a spindle drive. Here too, the joint production particularly advantageously allows intermediate steps in the production to be omitted and quality controls to be reduced.

One particularly advantageous refinement of a valve arrangement according to an aspect of the invention, in which the first gearwheel and the outer thread or the first gearwheel and the inner thread are produced as a single-piece injection molding, additionally has a magnetic field sensor, wherein, additionally, a magnet is arranged in a manner connected to the valve plunger such that the setting of the valve can be detected by the magnetic field sensor, and wherein the first gearwheel and the outer thread or the first gearwheel and the inner thread are produced in a joint injection molding, the latter also connecting the magnet to the valve plunger in that the magnet is encapsulated during the production. This makes it possible in a manner particularly economical in terms of production for the first gearwheel and the outer thread or the first gearwheel and the inner thread to be produced in one go and, simultaneously, for an additional magnet to be arranged on the valve plunger. This in turn allows increased process reliability owing to a reduced number of process steps and a reduced need for quality controls.

In a particularly advantageous embodiment of a valve arrangement according to an aspect of the invention, a mechanical restoring element or a spring is connected to the valve plunger and a valve housing such that the valve plunger is rotated back into the starting position, preferably into the closed setting, if a greater torque does not act on the first gearwheel. This particularly advantageously makes it possible, for example in the event of failure of the electric motor, for the valve plunger still to reach a defined state, that is to say the starting position or an emergency setting.

In a further particularly advantageous embodiment of a valve arrangement according to an aspect of the invention, the valve plunger is guided in one or more plain bearings. Such guidance particularly advantageously allows a stabilized movement sequence of plunger movements.

In a particularly advantageous embodiment of a valve arrangement according to an aspect of the invention, an additional sleeve is arranged on the valve housing around the valve plunger such that just an annular gap, which is at least a factor of 10 smaller than the diameter of the plunger, is present between the valve plunger and the inner wall of the sleeve, and the sleeve bears with its outer wall against the housing. Consequently, for example, the advantage is attained that soot and other dirt are kept away better from the valve housing in general and from the bearing region of the valve in particular.

In a further particularly advantageous embodiment of a valve arrangement according to an aspect of the invention, at least one ring-like seal is situated around the valve plunger such that it bears sealingly against the valve housing and the valve plunger. This particularly advantageously makes it possible to prevent undesired ingress of material, for example dirt, between the plunger and the housing.

In a further particularly advantageous embodiment of a valve arrangement according to an aspect of the invention, in which at least one ring-like seal is situated around the valve plunger such that it bears sealingly against the valve housing and the valve plunger, the ring-like seal is produced from an elastomer material. Particular advantages in the use of elastomer materials lie in the good processibility and good sealing properties thereof.

In a particularly advantageous refinement of a valve arrangement according to an aspect of the invention, in which at least one ring-like seal is situated around the valve plunger such that it bears sealingly against the valve housing and the valve plunger, and in which the ring-like seal is produced from an elastomer material, an element composed of polytetrafluoroethylene (PTFE) is arranged between the seal and the valve plunger. The arrangement of an element composed of PTFE between the seal and the valve plunger particularly advantageously allows the good sliding properties of PTFE to be utilized and thus the overall friction to be reduced and, at the same time, the wear of the elastomer parts to be greatly reduced.

In a further particularly advantageous refinement of a valve arrangement according to an aspect of the invention, the first gearwheel has a stop, and a further stop is arranged on the valve housing, said further stop being arranged in a manner corresponding to the stop on the gearwheel and limiting a rotational movement of the first gearwheel. The interaction of the stops results in a rotational movement of the first gearwheel—and thus also of the valve plunger fixedly connected thereto—about the axis of rotation of the gearwheel—and thus also about the longitudinal axis of the plunger—being limited. This particularly advantageously allows the movement of the plunger to be limited in a simple manner during an opening process of the valve/valve arrangement.

In a further particularly advantageous refinement of a valve arrangement according to an aspect of the invention, the first gearwheel has a stop that is preferably of encircling form. A further stop is arranged on the housing such that it is situated opposite in a manner corresponding to the stop on the gearwheel. By way of the interaction of the stops, a linear movement of the valve plunger in the direction of its longitudinal axis is limited. This particularly advantageously allows the movement of the plunger to be limited in a simple manner during an opening process of the valve/valve arrangement.

A further particularly advantageous embodiment of a valve arrangement according to an aspect of the invention is configured such that it withstands the temperatures in the use as an exhaust-gas recirculation valve arrangement. This particularly advantageously allows a valve arrangement according to the invention to be used in the context of exhaust gas recirculation.

In one particularly advantageous embodiment of a valve arrangement according to an aspect of the invention, at least one gearwheel is enlarged in extent in the axial direction, that is to say along the axis of rotation, such that sufficient engagement or overlap of the gearwheels is ensured over the entire stroke of the valve plunger. In this way, firstly it is particularly advantageously ensured that sufficient engagement is provided over the entire linear range of movement of the plunger. Secondly, such engagement is particularly advantageously achieved in a particularly direct and at the same time cost-effective manner, with the result that relatively complex compensation devices are unnecessary.

In a further particularly advantageous embodiment of a valve arrangement according to an aspect of the invention, at least one additional gearwheel imparts the rotational movement between the first gearwheel and the second gearwheel, and the first and second gearwheels are not in contact. This particularly advantageously allows further transmission geometries and larger transmission ratios to be made possible and/or thus a better response to spatial conditions with limitations. In one particular embodiment, a rotational movement-imparting gearwheel may be axially extended such that, in this way, the sufficient gearwheel engagement over the entire stroke range of the valve plunger is made possible. However, a plurality of rotational movement-imparting gearwheels, of which one or more may be extended in the axial direction, is also conceivable.

### BRIEF DESCRIPTION OF THE DRAWINGS

The invention will be discussed in more detail below on the basis of the figures of the drawings, wherein identical or similar elements are provided with the same reference signs. In the figures:

FIG. 1 shows a side view of a valve arrangement for a motor vehicle, having a valve plunger which is fixedly connected to a closure member, having a valve housing, having a valve seat, and having an electric motor by way of which the valve plunger is able to be moved;

FIG. 2 shows a side view of a valve arrangement for a motor vehicle, having a plurality of plain bearings;

FIG. 3 shows a perspective view of a valve arrangement for a motor vehicle; which has, in addition to a first gearwheel and a second gearwheel, a third gearwheel; and

FIG. 4 shows a perspective view of a valve arrangement for a motor vehicle, in which the valve plunger is fixedly connected to a component having an inner thread and the valve arrangement has an outer thread.

### DETAILED DESCRIPTION OF THE PRESENTLY PREFERRED EMBODIMENTS

For the sake of clarity, possible teeth of gearwheels which are designed in the form of toothed wheels are not indicated to some extent.

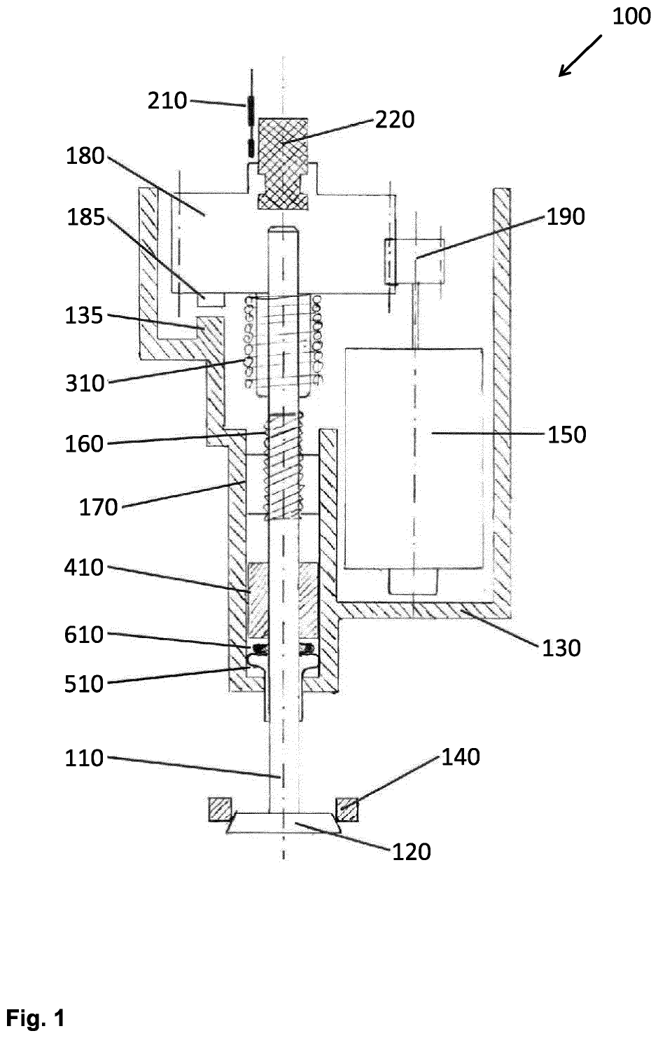

FIG. 1 shows, in a sectional drawing, a side view of an embodiment of a valve arrangement 100 according to an embodiment of the invention for a motor vehicle. A valve plunger 110 is fixedly connected to a closure member 120. The closure member 120 comes into contact with a valve seat 140 such that the contact region is leak-tight. The valve arrangement has a valve housing 130. A first gearwheel 180 is connected to the valve plunger 110. A second gearwheel 190 is connected to an electric motor 150, and is arranged such that it transmits a rotational movement directly to the first gearwheel 180. The valve plunger 110 has, in a sub-region, an outer thread 160 which runs in a threaded sleeve or spindle nut 170. The outer thread 160 and the threaded sleeve or spindle nut 170 together form a worm gear. A rotational movement of the valve plunger about its longitudinal axis thus simultaneously leads to a linear movement along its longitudinal axis. A mechanical restoring element 310 or a spring is connected to the valve plunger 110 and the valve housing 130 such that the valve plunger 110 is rotated back into the starting position if a greater torque does not act on the first gearwheel 180. The starting position is the closed setting of the valve arrangement/valve. A magnet 220 is connected to the valve plunger 110 such that a magnetic field sensor 210 detects the setting of the valve plunger. The valve plunger 110 is guided by a plain bearing 410. An additional sleeve 510 is arranged on the valve housing 130 around the valve plunger 110 such that just an annular gap, which is at least a factor of 10 smaller than the diameter of the plunger 110, is present between the valve plunger 110 and the inner wall of the sleeve 510, and the sleeve 510 bears with its outer wall against the housing 130. A ring-like (i.e., annular) seal 610 is situated around the valve plunger 110 such that it bears sealingly against the valve housing 130 and the valve plunger 110. The first gearwheel 180 has a stop 185, and a further stop 135 is arranged on the housing 130, the further stop being arranged in a manner corresponding to the stop 185 on the gearwheel 180 and limiting a rotational movement of the first gearwheel 180. The first gearwheel 180 is enlarged in extent in the longitudinal direction, that is to say along the axis of rotation, such that sufficient engagement or overlap of the gearwheels 180, 190 is ensured over the entire stroke of the valve plunger 110.

The fixing of a restoring element 310 or a spring at the valve housing is not shown for reasons of clarity.

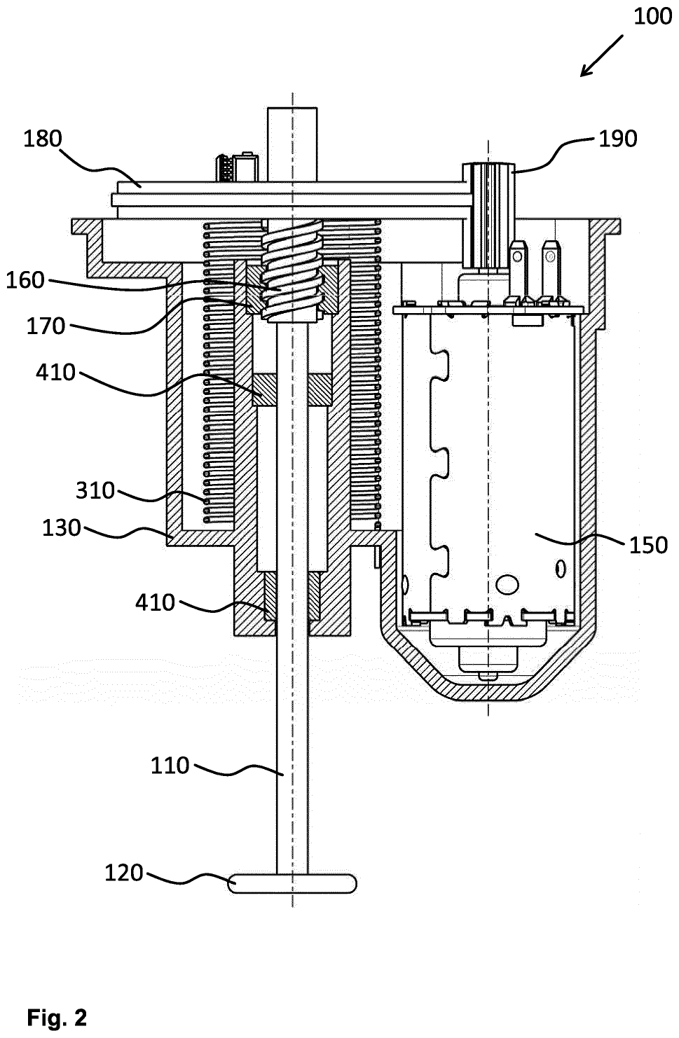

FIG. 2 shows, in a sectional drawing, a side view of an exemplary embodiment of a valve arrangement 100 according to the invention for a motor vehicle. The valve arrangement shown in FIG. 2 differs from the valve arrangement shown in FIG. 1 in that, here, the second gearwheel 190 is enlarged in extent in the longitudinal direction, that is to say along the axis of rotation, such that sufficient engagement or overlap of the gearwheels 180, 190 is ensured over the entire stroke of the valve plunger 110.

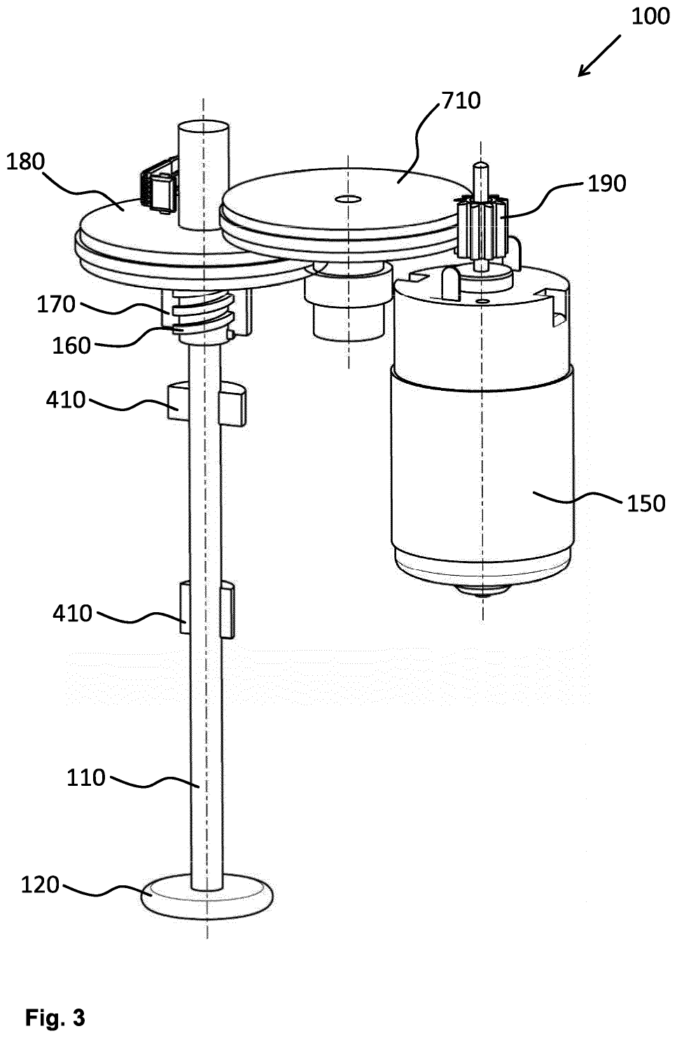

FIG. 3 shows, in a perspective view, an exemplary embodiment of a valve arrangement 110 according to the invention. The valve arrangement shown in FIG. 3 differs from the valve arrangements shown in FIGS. 1 and 2 in that, here, the rotational movement between the first gearwheel 180 and the second gearwheel 190 is imparted by an additional gearwheel 710. The first gearwheel 180 and the second gearwheel 190 are not in contact in this case.

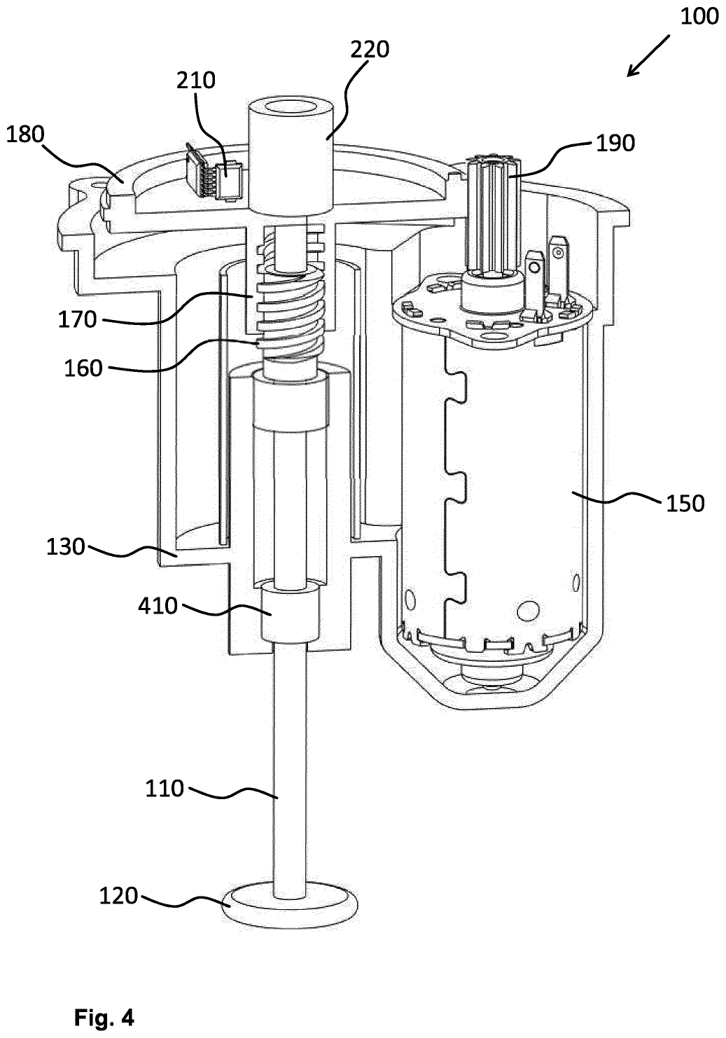

FIG. 4 shows, in a perspective view, an exemplary embodiment of a valve arrangement 100 according to the invention, in which the valve plunger 110 is fixedly connected to a component having an inner thread 170 and the valve arrangement 100 has an outer thread 160. A valve plunger 110 is fixedly connected to a closure member 120 at one end of the plunger and to a first gearwheel 180. The gearwheel 180 has an inner thread 170. An outer thread 160 surrounds the plunger 110 but is not connected thereto. In other words: the plunger 110 projects through the outer thread 160 and can rotate about its longitudinal axis in relation to the outer thread or move through the outer thread along its longitudinal axis. The inner thread 170 runs on the outer thread 160, which is fixedly connected to the housing 130. When the motor 150 transmits a rotational movement to the second gearwheel 190, which engages with the first gearwheel 180, the first gearwheel 180 is also set in rotation. The inner thread 170 and the outer thread 160 together form a worm gear, with the result that a rotational movement of the first gearwheel 180 also leads to a linear movement of the first gearwheel 180 along its axis of rotation. Since the first gearwheel 180 is fixedly connected to the valve plunger 110, the plunger 110 also undergoes a rotational movement about the axis of rotation of the gearwheel, which is thus also the axis of rotation of the plunger, and simultaneously a linear movement along this axis of rotation.

Thus, while there have been shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1-17. (canceled)

18. A valve arrangement (100) for a motor vehicle, comprising:
a valve plunger (110),
a closure member (120) to which the valve plunger (110) is fixedly connected;
a valve housing (130);
a valve seat (140);
an electric motor (150) configured to move the valve plunger (110);
a worm gear with an outer thread (160) and an inner thread (170);
a first gearwheel coupled to the valve plunger (110);
a second gearwheel (190), the second gearwheel (190) being arranged and configured to transmit a rotational movement directly, or via an intermediate gearing, to the first gearwheel (180); and
a sleeve,
wherein:
in the worm gear:
the inner thread (170) is formed as a part of the sleeve on an inner surface of the sleeve, and the valve plunger has, at least in a sub-region thereof, the outer thread (160), or
the inner thread (170) is formed as a spindle nut arranged in the sleeve and having the inner thread (170), and the valve plunger has, at least in a sub-region thereof, the outer thread (160), or
the inner thread (170) is formed on the first gearwheel (180), and the first gearwheel is fixedly connected to the valve plunger (110), and the outer thread (160) is formed on the valve arrangement (100).

19. The valve arrangement (100) as claimed in claim 18, further comprising:
a magnetic field sensor (210); and
a magnet (220) arranged connected to the valve plunger (110) such that a setting of the valve is detectable by the magnetic field sensor (210).

20. The valve arrangement (100) as claimed in claim 19, wherein the valve plunger (110) comprises the outer thread (160).

21. The valve arrangement (100) as claimed in claim 19, wherein the outer thread (160) is attached to the valve plunger (110) via a separate second sleeve.

22. The valve arrangement (100) as claimed in claim 19, wherein the outer thread (160) or the inner thread (170) is attached to the valve plunger (110) by injection molding.

23. The valve arrangement (100) as claimed in claim 22, wherein the first gearwheel (180) and the outer thread (160) are injection molded as a single piece, or the first gearwheel (180) and the inner thread (170) are injection molded as a single piece.

24. The valve arrangement (100) as claimed in claim 23, wherein the first gearwheel (180) and the inner thread (170) are produced in a joint injection molding that also connects the magnet (220) to the valve plunger (110) by encapsulating the magnet (220).

25. The valve arrangement (100) as claimed in claim 18, further comprising a mechanical restoring element (310), or a spring, connected to the valve plunger (110) and a valve housing (130) so as to apply a first torque to the valve plunger (110) such that the valve plunger (110) is rotated back into a closed valve setting, unless a second torque, greater than the first torque, acts on the first gearwheel (180).

26. The valve arrangement (100) as claimed in claim 18, wherein the valve plunger (110) is guided in one or more plain bearings (410).

27. The valve arrangement (100) as claimed in claim 18, further comprising an additional sleeve (510) arranged on the valve housing (130) around the valve plunger (110) such that an annular gap, which is at least a factor of 10 smaller than the diameter of the plunger (110), is between the valve plunger (110) and the inner wall of the sleeve (510), and the sleeve (510) bears with its outer wall against the housing (130).

28. The valve arrangement (100) as claimed in claim 18, further comprising at least one ring-like seal (610) arranged around the valve plunger (110) such that the at least one ring-like seal (610) bears sealingly against the valve housing (130) and the valve plunger (110).

29. The valve arrangement (100) as claimed in claim 28, wherein the at least one ring-like seal (610) is made of an elastomer material.

30. The valve arrangement (100) as claimed in claim 29, further comprising an element composed of PTFE (620) arranged between the at least one ring-like seal (610) and the valve plunger (110).

31. The valve arrangement (100) as claimed in claim 18, wherein the first gearwheel (180) has a stop (185), and a further stop (135) is arranged on the housing (130), said further stop being arranged in a manner corresponding to the stop (185) on the gearwheel (180) and limiting a rotational movement of the first gearwheel (180).

32. The valve arrangement (100) as claimed in claim 18, which is configured such that it withstands the temperatures in use as an exhaust-gas recirculation valve arrangement (100).

33. The valve arrangement (100) as claimed in claim 18, further comprising at least one additional gearwheel (710) configured to impart the rotational movement between the first gearwheel (180) and the second gearwheel (190), and wherein the first gearwheel (180) and the second gearwheel (190) are not in contact.

34. The valve arrangement (100) as claimed in claim 18, wherein at least one gearwheel (180, 190, 710) is enlarged in extent along the axis of rotation such that sufficient engagement or overlap of the gearwheels (180, 190) is ensured over the entire stroke of the valve plunger (110).
